(19) United States
(12) Patent Application Publication
(10) Pub. No.: US 2003/0146094 A1
(43) Pub. Date: Aug. 7, 2003

(54) Method for controlling a fuel concentration in an anode liquid of a fuel cell, and associated device

(76) Inventor: Walter Preidel, Erlangen (DE)

Correspondence Address: LERNER AND GREENBERG, P.A., Post Office Box 2480, Hollywood, FL, 33022-2480, US

(21) Appl. No.: 10/368,154

(22) Filed: Feb. 18, 2003

Related U.S. Application Data
(63) Continuation of application No. PCT/DE01/02976, filed on Aug. 3, 2001.

(30) Foreign Application Priority Data
Aug. 16, 2000 (DE) 100 39 959.2

(51) Int. Cl. G01N 27/26; H01M 8/00

(52) U.S. Cl. 204/431; 205/785.5; 429/12; 429/13

(57) ABSTRACT

In a fuel cell, particularly a direct methanol fuel cell, in which a waste gas develops at the anode and at the cathode, a carbon dioxide concentration is measured in the waste gas. The carbon dioxide concentration is used to determine the loss of fuel through the membrane of the fuel cell. To this end, the corresponding device is provided with a carbon dioxide sensor that is arranged inside the gas stream.

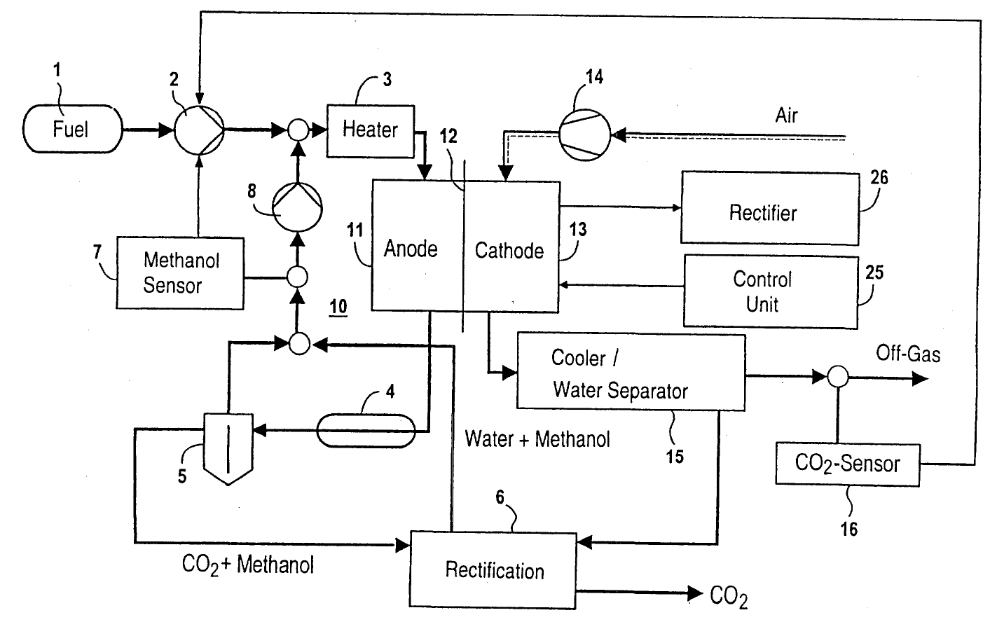

### CROSS-REFERENCE TO RELATED APPLICATION

This application is a continuation of copending International Application No. PCT/DE01/02976, filed Aug. 3, 2001, which designated the United States and which was not published in English.

### BACKGROUND OF THE INVENTION

1. Field of the Invention

The invention relates to a method for controlling the fuel concentration in the anode liquid of a fuel cell with anode, membrane, and cathode. An off-gas or exhaust gas is produced both at the anode and at the cathode. In addition, the invention also relates to a device having the necessary means for carrying out the method. In the invention, the fuel is preferably, but not exclusively, methanol.

Fuel cells are operated with liquid or gaseous fuels. If the fuel cell operates with hydrogen, a hydrogen infrastructure or a reformer for generating the gaseous hydrogen from the liquid fuel is required. Examples of liquid fuels are gasoline or alcohol, such as ethanol or methanol. A DMFC (“Direct Methanol Fuel Cell”) operates directly with liquid methanol as the fuel. The function and status of the DMFCs are described in detail by the inventor in “VIK-Berichte”, No. 214 (November 1999), pp. 55-62.

Fuel cell systems comprise a large number of individual fuel cell units, which together form a fuel cell stack. Such fuel cell stacks are also known as “stacks” for short to those of skill in the pertinent art. In the direct methanol fuel cell operated with methanol as fuel, off-gases are formed in the fuel cell at both the anode and the cathode.

In the direct methanol fuel cell (DMFC), the fuel methanol is mixed with water on the anode side and is pumped through the stack with a metering pump. The methanol is partially consumed by the anode reaction and carbon dioxide is formed. Another part of the methanol is conveyed through the membrane to the cathode as a result of permeation and electroosmosis and is directly oxidized to form carbon dioxide at the catalyst of the cathode.

The anode liquid with the gas/vapor mixture is separated into gas and liquid when it leaves the anode. As much further carbon dioxide as possible is removed from the liquid, and then the liquid is fed back to the anode with the pump. To ensure that the methanol concentration of this liquid does not become too low, sufficient quantities of methanol have to be added. The quantity of methanol which corresponds to the electric current can be calculated from the current flux, but the additional quantity which replaces the loss resulting from electroosmosis and permeation cannot be qualitatively determined, and consequently the anode liquid would have an insufficient concentration.

The latter problem can be solved by using a constant excess factor. However, since the losses in individual cases are dependent on the way in which the methanol-fed fuel cell is operated, since the electroosmosis and permeation are differently superimposed depending on the current density in the cell, over a prolonged period either the levels of methanol will rise or, if the excess is insufficient, the methanol concentration will be insufficient. In this situation, there is a very high risk of the inadequately supplied cells of the fuel cell stack undergoing polarity reversal. However, a reversal of the polarity of the cells can lead to damage to the cell which cannot be regenerated.

In the prior art, the quantity of methanol in the direct methanol fuel cell is calculated by means of the current flux and is increased by a constant factor, e.g. 1.5 or 2.0. This compensates for the methanol losses, but accepts that the methanol concentration will not be at an optimum for the prevailing current density. Since the methanol tends to have to be metered in excess, in order to avoid an insufficient supply and therefore the risk of polarity reversal, the methanol loss is greater than necessary.

In very general terms, it is the case that the efficiency of the fuel cell system described with the above operating concept is by no means optimum and is in need of improvement.

### SUMMARY OF THE INVENTION

It is accordingly an object of the invention to provide a method of controlling a fuel concentration in the anode liquid of a fuel cell, and a corresponding device, which overcome the above-mentioned disadvantages of the heretofore-known devices and methods of this general type and which improve the control or regulation of the fuel concentration in the anode liquid of a direct methanol fuel cell.

With the foregoing and other objects in view there is provided, in accordance with the invention, a method in a fuel cell having an anode, a membrane, and a cathode, i.e., a method for controlling a fuel concentration in an anode liquid of the fuel cell. The method comprises the steps of generating a cathode off-gas during an operation of the fuel cell, measuring a carbon dioxide concentration in the cathode off-gas, and deducing from the carbon dioxide concentration a fuel loss taking place via the membrane of the fuel cell.

In other words, in the invention, the measurement of the carbon dioxide concentration in the cathode off-gas advantageously makes it possible to record the fuel loss via the membrane. A commercially available sensor which is arranged in the gas stream, for example downstream of the cooler and admission pressure controller, is used to measure the concentration.

In accordance with an added feature of the invention, off-gas is produced at the anode and at the cathode of the fuel cell. In a preferred embodiment, the fuel is methanol and the fuel cell is preferably a DMFC.

In accordance with an additional feature of the invention, the carbon dioxide concentration is measured with a sensor exposed in a gas stream of the off-gas.

In accordance with another feature of the invention, the carbon dioxide concentration is also measured in the gas stream in units for cooling and controlling an admission pressure that is present in the fluid loop.

In accordance with a further feature of the invention, the deducing step comprises converting the carbon dioxide concentration into methanol, with one mole of carbon dioxide corresponding to one mole of methanol.

With the above and other objects in view there is also provided, in accordance with the invention, in combination with a fuel cell, a device for carrying out the above-outlined method. In the device, a carbon dioxide sensor is disposed in the gas stream.

More specifically, in accordance with a concomitant feature of the invention, the carbon dioxide sensor is disposed in the gas stream downstream of a cooler which may form part of an admission pressure controller.

Other features which are considered as characteristic for the invention are set forth in the appended claims.

Although the invention is illustrated and described herein as embodied in a method for controlling the fuel concentration in the anode liquid of a fuel cell, and associated device, it is. nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE DRAWING

The single figure is a diagrammatic illustration of an individual unit, specifically of a DMFC fuel cell, with the associated system components required for the operation of the fuel cell.

### DESCRIPTION OF THE PREFERRED EMBODIMENTS

Referring now to the figures of the drawing in detail, there is shown a methanol tank 1 with a downstream metering pump 2 and a heating device 3, via which the liquid methanol passes as operating medium to a fuel cell unit 10. The fuel cell unit 10 is configured as a direct methanol fuel cell (DMFC) and is substantially characterized by an anode 11, a membrane 12, and a cathode 13. The anode part is assigned a cooler 4, a CO₂ separator 5, a unit 6 for rectification, and a methanol sensor 7. A further metering pump 8 is used to feed methanol back into the fuel circuit.

On the cathode side, there is a compressor 14 for air, a cooler or water separator 15 for the cathode liquid, and a CO₂ sensor 16. Furthermore, a unit 25 for controlling the fuel cell unit 10 and, if appropriate, an electrical inverter 26 are present for operating the system.

In the exemplary DMFC, there are primary and secondary fluid circuits or loops. In the primary circuit, the methanol/water mixture is fed to the anode 11 and air is fed to the cathode 13 of the fuel cell 10. In the secondary circuit, the CO₂ is separated out of the residual fuel and the latter is returned to the fuel circuit. Furthermore, the cathode off-gas is passed via the cooler or water separator 15 in the off-gas fluid circuit. Then, the CO₂ content, which is a measure of the methanol loss via the membrane 12 of the fuel cell, in the off-gas is measured. The measurement signal is fed back to the primary metering pump 2 or it is used by a controller to adjust the fuel pump 2. The CO₂ sensor 16 in the figure is a commercially available sensor which is arranged in the gas stream, advantageously downstream of the cooler 15 and the admission pressure controller which is present. The CO₂ concentration is therefore measured in molar terms.

One mole of carbon dioxide also corresponds to one mole of methanol. The quantity of air on the cathode side is known on account of the compressor output or can be determined by measuring the air flow rate.

A certain systematic error is concealed in the quantity of carbon dioxide determined using the sensor, since a small proportion of the carbon dioxide which is formed at the anode as a result of the electrochemical reaction can diffuse through the membrane to the cathode, so that the air used has a small and under certain circumstances also slightly fluctuating carbon dioxide concentration. However, since there is no additional electroosmosis active for the carbon dioxide, unlike for methanol, this fault can be tolerated.

The metering of the methanol results from the current flux and is to be calculated additively from the carbon dioxide concentration on the cathode side. For reliable operation, depending on the membrane electrolyte assembly (MEA) and stack properties, an additional flow of methanol can be added to this basis resulting from the Faraday current, on the one hand, and the current loss, on the other hand. The lambda for methanol is then increased to 1.05 to 1.5, depending on the specific requirements.

With the system illustrated in the figure and the operating concept described with reference to the figure, the additive use of the carbon dioxide concentration on the cathode side in the outgoing air for controlling the fuel cell system is of primary importance. It is no longer absolutely imperative to measure the methanol concentration in the fuel circuit.

In practice, the DMFC is equipped with a carbon dioxide sensor in the off-gas. Characteristic curve measurements have successfully been carried out for verification purposes.

It will be readily understood by those of skill in the art that the solution to the problem which has been described above on the basis of a DMFC operated with methanol as its fuel can be transferred to fuel cells operated with other fuels.

I claim:

1. In a fuel cell having an anode, a membrane, and a cathode, a method for controlling a fuel concentration in an anode liquid of the fuel cell, which comprises generating a cathode off-gas during an operation of the fuel cell, measuring a carbon dioxide concentration in the cathode off-gas, and deducing from the carbon dioxide concentration a fuel loss taking place via the membrane of the fuel cell.

2. The method according to claim 1, which comprises generating an off-gas at the anode and at the cathode of the fuel cell.

3. The method according to claim 1, wherein the fuel is methanol.

4. The method according to claim 1, which comprises measuring the carbon dioxide concentration with a sensor exposed in a gas stream of the off-gas.

5. The method according to claim 4, which comprises also measuring the carbon dioxide concentration in the gas stream in units for cooling and controlling an admission pressure present in the fluid circuit.

6. The method according to claim 3, wherein the deducing step comprises converting the carbon dioxide concentration into methanol, with one mole of carbon dioxide corresponding to one mole of methanol.

7. In combination with a fuel cell, a device for carrying out the method according to claim 1, comprising a carbon dioxide sensor disposed in a gas stream.

8. The device according to claim 7, which comprises a cooler disposed in a loop conducting the gas stream, and wherein said carbon dioxide sensor is disposed in the gas stream downstream of said cooler.

9. The device according to claim 8, wherein said cooler forms a part of an admission pressure controller.
